(19) United States
(12) Patent Application Publication
(10) Pub. No.: US 2014/0298908 A1
(43) Pub. Date: Oct. 9, 2014

(54) VIBRATION ELEMENT, ELECTRONIC DEVICE, ELECTRONIC APPARATUS, AND MOVING OBJECT

(71) Applicant: Seiko Epson Corporation, Tokyo (JP)

(72) Inventor: Fumio ICHIKAWA, Suwa (JP)

(73) Assignee: Seiko Epson Corporation, Tokyo (JP)

(21) Appl. No.: 14/244,104

(22) Filed: Apr. 3, 2014

(30) Foreign Application Priority Data
Apr. 5, 2013 (JP) 2013-079256

(51) Int. Cl. G01P 1/00; G01P 3/16

(52) U.S. Cl. CPC G01P 1/00; G01P 3/16
USPC 73/504.12

(57) ABSTRACT

A vibration element includes a base section, a support arm extending from the base section, a driving vibration arm extending from the support arm in a direction intersecting with the extending direction of the support arm, a drive section provided to the driving vibration arm, and having a first electrode layer, a second electrode layer, and a first piezoelectric layer disposed between the first electrode layer and the second electrode layer, the first electrode layer being disposed on the driving vibration arm side, and a monitor section adapted to detect a vibration of the driving vibration arm, provided to the driving vibration arm, and having a third electrode layer, a fourth electrode layer, and a second piezoelectric layer disposed between the third electrode layer and the fourth electrode layer, the third electrode layer being disposed on the driving vibration arm side.

### BACKGROUND

1. Technical Field

The present invention relates to a vibration element, an electronic device, an electronic apparatus, and a moving object.

2. Related Art

In the past, angular velocity sensors have been used in an autonomous control technology of a posture of a ship, a plane, a rocket, and so on. Recently, angular velocity sensors are used, for example, for body control in a vehicle, vehicle position detection of a car navigation system, and vibration control correction (so called image correction) of a digital camera, a video camera, and a cellular phone. Due to miniaturization of such electronic apparatuses described above, miniaturization and height reduction (lower profile) of the angular velocity sensor is required.

To cope with the above circumstances, the miniaturization has been achieved by a manufacturing method for forming a vibration element for an angular velocity sensor having a driving vibration arm and a detecting vibration arm using a machining process or an etching process of a piezoelectric material. However, in order to cope with further miniaturization, JP-A-2009-156832 discloses a technology for forming a vibration element by stacking a piezoelectric element and an electrode on a semiconductor substrate such as single-crystal silicon, and then performing microfabrication thereon.

However, the vibration element formed by stacking the piezoelectric element and the electrode on the semiconductor substrate and then performing the microfabrication thereon is high in capacitance, and has a problem that it is very difficult to excite a flexural vibration of the driving vibration arm because of the high impedance.

### SUMMARY

An advantage of some aspects of the invention is to solve at least a part of the problems described above, and an aspect of the invention can be implemented as the following forms or application examples.

### Application Example 1

This application example is directed to a vibration element including a base section, a support arm extending from the base section, a driving vibration arm extending from the support arm in a direction intersecting with the extending direction of the support arm, a drive section provided to the driving vibration arm, and having a first electrode layer, a second electrode layer, and a first piezoelectric layer disposed between the first electrode layer and the second electrode layer, the first electrode layer being disposed on the driving vibration arm side, and a monitor section adapted to detect a vibration of the driving vibration arm, provided to the driving vibration arm, and having a third electrode layer, a fourth electrode layer, and a second piezoelectric layer disposed between the third electrode layer and the fourth electrode layer, the third electrode layer being disposed on the driving vibration arm side.

According to this application example, since the drive section having the first piezoelectric layer disposed between the first electrode and the second electrode is large in capacitance and high in impedance, it is difficult to drive the flexural vibration of the driving vibration arm. Therefore, by disposing the monitor section on the driving vibration arm, it is possible to amplify the charge corresponding to the amplitude of the flexural vibration of the driving vibration arm generated in the monitor section, and then apply the result to the drive circuit as a monitor voltage. Therefore, there is obtained an advantage that a constant voltage sufficient to drive the flexural vibration is supplied, and thus, it is possible to stably drive the flexural vibration of the driving vibration arm.

### Application Example 2

This application example is directed to the vibration element according to the application example described above, wherein the drive section and the monitor section are disposed side by side having a distance from each other in a width direction of the driving vibration arm.

According to this application example, by disposing the drive section and the monitor section side by side with a distance from each other in the width direction of the driving vibration arm, it is possible to generate the charge corresponding to the amplitude of the vibration, which is caused by an action of expanding and contracting in the opposite phases to the vibration of the drive section, in the monitor section to apply the monitor voltage to the drive circuit in the case in which the flexural vibration having a displacement in a direction intersecting with the longitudinal direction of the driving vibration arm, which is driven by the expanding and contracting actions of the drive section, is driven. Therefore, there is obtained an advantage that a constant voltage sufficient to drive the flexural vibration is supplied, and thus, it is possible to stably drive the flexural vibration of the driving vibration arm.

### Application Example 3

This application example is directed to the vibration element according to the application examples described above, wherein the drive section includes a first drive section and a second drive section disposed side by side having a distance from each other in a width direction of the driving vibration arm.

According to this application example, by disposing the first drive section and the second drive section side by side with a distance from each other in the width direction of the driving vibration arm, it becomes possible to expand and contract the first drive section and the second drive section in the respective phases opposite to each other to thereby make it possible to dramatically decrease the impedance. Therefore, there is obtained an advantage that it is possible to easily drive the flexural vibration of the driving vibration arm.

### Application Example 4

This application example is directed to the vibration element according to the application examples described above, wherein the monitor section is disposed nearer to the base section than the drive section in a plan view of the driving vibration arm.

According to this application example, since the monitor section is located nearer to the base section than the drive section in the monitor section and the drive section disposed on the driving vibration arm, it is possible to form the drive section having sufficient length in the longitudinal direction of the driving vibration arm without cutting the connection wiring between the monitor section and the connection terminal section. Therefore, there is obtained an advantage that the impedance can be prevented from deteriorating, and it is possible to easily drive the flexural vibration of the driving vibration arm.

### Application Example 5

This application example is directed to the vibration element according to the application examples described above, wherein the monitor section is disposed on one side of the driving vibration arm in a direction intersecting with the support arm.

According to this application example, by disposing the monitor section on one side of the driving vibration arm in the direction intersecting with the support arm, it is possible to form the drive section having sufficient length in the longitudinal direction of the driving vibration arm without cutting the connection wiring between the drive section and the connection terminal section. Therefore, there is obtained an advantage that the impedance can be prevented from deteriorating, and it is possible to easily drive the flexural vibration of the driving vibration arm.

### Application Example 6

This application example is directed to the vibration element according to the application examples described above, wherein the monitor section is disposed between the first drive section and the second drive section, and a center line with respect to a width direction of the monitor section and a center line with respect to a width direction of the driving vibration arm fail to intersect with each other in a plan view of the driving vibration arm.

According to this application example, by disposing the center line with respect to the width direction of the monitor section and the center line with respect to the width direction of the driving vibrating arm in parallel to each other in the driving vibration arm in which the flexural vibration having the displacement in the direction intersecting with the longitudinal direction of the driving vibration arm is driven, it is possible to prevent the charges generated due to the expansion and contraction of the center-line portion with respect to the width direction of the driving vibration arm from being canceled out to thereby obtain the monitor voltage. Therefore, it is possible to apply the monitor voltage to the drive circuit, and there is obtained an advantage that the sufficient voltage for driving the flexural vibration is applied, and thus, it is possible to stably drive the flexural vibration of the driving vibration arm.

### Application Example 7

This application example is directed to the vibration element according to the application examples described above, wherein a detecting vibration arm extending from the base section in the direction intersecting with the extending direction of the support arm is provided.

According to this application example, by adopting the structure in which the detecting vibration arm extending from the base section in the direction intersecting with the extending direction of the support arm is provided to the vibration element having the driving vibration arm extending in a direction intersecting the extending direction of the support arm from the support arm extending from the base section, in the case in which an angular velocity ω is applied to the vibration element, the Coriolis force acts, the flexural vibration is excited in the detecting vibration arm, and the charges are generated. Therefore, there is obtained an advantage that the angular velocity ω applied to the vibration element can be obtained based on the charges.

### Application Example 8

This application example is directed to the vibration element according to the application examples described above, wherein the base section is provided with terminals electrically connected respectively to the drive section and the monitor section.

According to this application example, by providing the terminals electrically connected to the drive section and the monitor section to the base section of the vibration element, there is obtained an advantage that it is possible to electrically and mechanically bond the vibration element to the mounting terminals of a package or the like without hindering the flexural vibrations of the driving vibration arm and the detecting vibration arm.

### Application Example 9

This application example is directed to a vibration element including a driving vibration arm extending along an X-Y plane defined by an X axis and a Y axis, and vibrating in at least an X-axis direction assuming three imaginary axes perpendicular to each other as the X axis, the Y axis, and a Z axis, and a detecting vibration arm extending along the X-Y plane defined by the X axis and the Y axis, and being displaced along the X-Y plane when an angular velocity around the Z axis is applied, and the driving vibration arm is provided with a monitor section adapted to detect the vibration.

### Application Example 10

This application example is directed to an electronic device including the vibration element according to the application example described above, and a circuit element.

According to this application example, there is obtained an advantage that it is possible to obtain an electronic device capable of stably driving the driving vibration arm of the vibration element.

### Application Example 11

This application example is directed to an electronic apparatus including the vibration element according to the application example described above.

According to this application example, there is obtained an advantage that it is possible to configure an electronic apparatus equipped with the vibration element capable of stably driving the driving vibration arm.

### Application Example 12

This application example is directed to a moving object including the vibration element according to the application examples described above.

According to this application example, there is obtained an advantage that it is possible to configure a moving object equipped with the vibration element capable of stably driving the driving vibration arm.

### BRIEF DESCRIPTION OF THE DRAWINGS

The invention will be described with reference to the accompanying drawings, wherein like numbers reference like elements.

FIGS. 1A and 1B are schematic diagrams showing a structure of a vibration element according to a first embodiment of the invention, wherein FIG. 1A is a plan view, and FIG. 1B is a cross-sectional view along the A-A line.

FIG. 2 is a schematic diagram showing a cross-sectional view of the vibration element according to the first embodiment of the invention along the B-B line shown in FIG. 1A, and a circuit configuration.

FIGS. 3A through 3C are each a cross-sectional view showing a modified example of the vibration element according to the first embodiment of the invention along the A-A line shown in FIG. 1A, wherein FIG. 3A is a cross-sectional view showing modified example 1, FIG. 3B is a cross-sectional view showing modified example 2, and FIG. 3C is a cross-sectional view showing modified example 3.

FIGS. 4A and 4B are schematic diagrams showing a structure of a vibration element according to a second embodiment of the invention, wherein FIG. 4A is a plan view, and FIG. 4B is a cross-sectional view along the C-C line.

FIG. 5 is a plan view showing a structure of modified example 1 of the vibration element according to the second embodiment of the invention.

FIG. 6 is a plan view showing a structure of modified example 2 of the vibration element according to the second embodiment of the invention.

FIG. 7 is a plan view showing a structure of modified example 3 of the vibration element according to the second embodiment of the invention.

FIG. 8 is a plan view showing a structure of modified example 4 of the vibration element according to the second embodiment of the invention.

FIGS. 9A and 9B are schematic diagrams showing a structure of an electronic device equipped with the vibration element according to the invention, wherein FIG. 9A is a plan view, and FIG. 9B is a cross-sectional view along the D-D line.

FIG. 10 is a perspective view showing a configuration of a mobile type (or a laptop type) personal computer as an electronic apparatus equipped with the vibration element according to the invention.

FIG. 11 is a perspective view showing a configuration of a cellular phone (including PHS) as an electronic apparatus equipped with the vibration element according to the invention.

FIG. 12 is a perspective view showing a configuration of a digital camera as an electronic apparatus equipped with the vibration element according to the invention.

FIG. 13 is a perspective view showing a configuration of a vehicle as a moving object equipped with the vibration element according to the invention.

### DESCRIPTION OF EXEMPLARY EMBODIMENTS

Some embodiments of the invention will hereinafter be explained in detail with reference to the accompanying drawings.

### Vibration Element

### First Embodiment

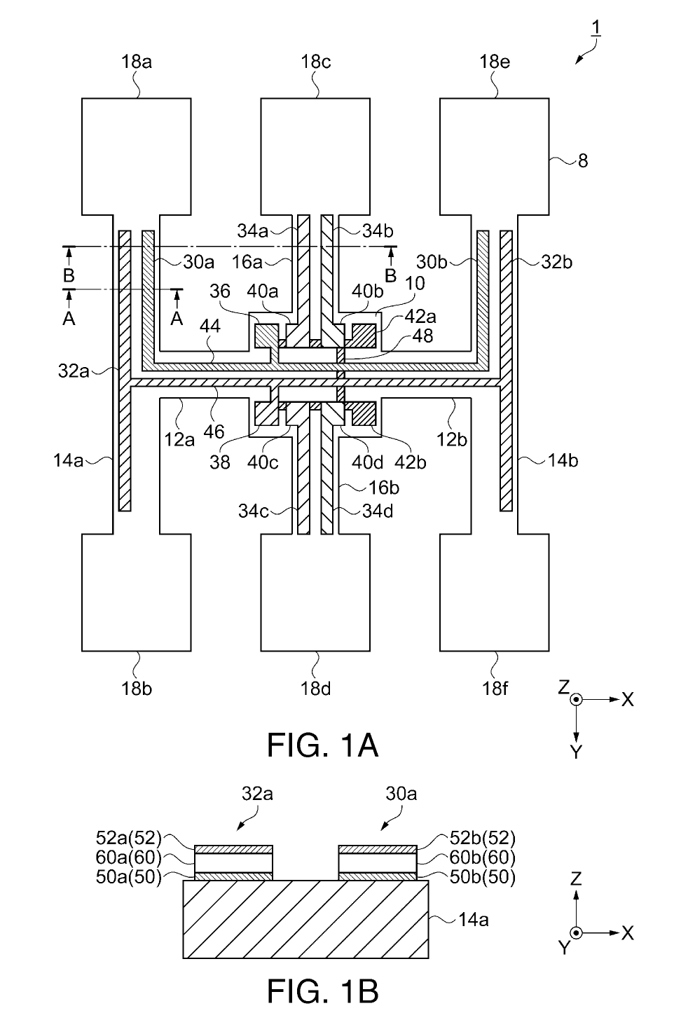

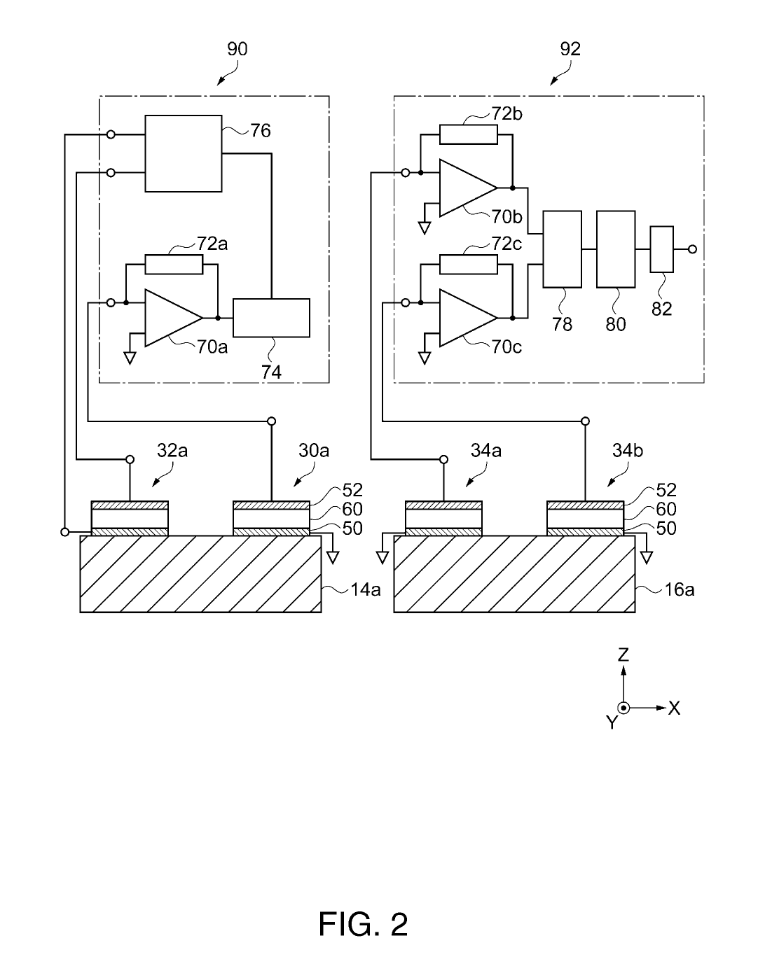

FIGS. 1A and 1B are schematic diagrams showing a structure of a vibration element according to a first embodiment of the invention, wherein FIG. 1A is a plan view, and FIG. 1B is a cross-sectional view along the A-A line in FIG. 1A. Further, FIG. 2 is a schematic diagram showing a cross-sectional view of the vibration element according to the first embodiment of the invention along the B-B line shown in FIG. 1A, and a circuit configuration. Here, in FIGS. 1A and 1B, and FIGS. 2 through 9A, and 9B described later, there are shown X axis, Y axis, and Z axis as three axes perpendicular to each other, and the tip side of the arrow shown in the drawing is defined as “+ side,” and the base end side is defined as “− side” for the sake of convenience of explanation. Further, hereinafter, a direction parallel to the X axis is referred to as an “X-axis direction,” a direction parallel to the Y axis is referred to as a “Y-axis direction,” and a direction parallel to the Z axis is referred to as a “Z-axis direction.”

It should be noted that a vibration element having a structure called double T type used for an angular sensor will be explained as an example of the vibration element according to the embodiment of the invention.

The vibration element 1 shown in FIG. 1A is formed of a substrate 8 provided with a base section 10, two support arms 12a, 12b extending from the base section 10, two driving vibration arms 14a, 14b provided with monitor sections 30a, 30b and drive sections 32a, 32b, and two detecting vibration arms 16a, 16b provided with detection sections 34a, 34b, 34c, and 34d.

As shown in FIG. 1A, the support arm 12a extends toward the − side of the X-axis direction, and the support arm 12b extends toward the + direction of the X-axis direction, respectively.

Further, the two driving vibration arms 14a, 14b each have a rectangular shape, and extend from the support arms 12a, 12b in a direction (the Y-axis direction) intersecting with the extending direction of the support arms 12a, 12b, respectively. The central portion of the driving vibration arm 14a joins a tip portion of the support arm 12a located on an opposite side (the − side of the X-axis direction) to the side joining the base section 10. Further, the central portion of the driving vibration arm 14b joins a tip portion of the support arm 12b located on an opposite side (the + side of the X-axis direction) to the side joining the base section 10.

Further, the two detecting vibration arms 16a, 16b each have a roughly rectangular shape, join the base section 10 at respective end portions in the longitudinal direction, and extend in a direction (the Y-axis direction) intersecting with the extending direction of the support arms 12a, 12b. The detecting vibration arm 16a extends toward the − side of the Y-axis direction, and the detecting vibration arm 16b extends toward the + side of the Y-axis direction, respectively.

On both of tip portions of the driving vibration arms 14a, 14b in the longitudinal direction, there are disposed weight sections 18a, 18b, 18e, and 18f having a width larger than the width of the driving vibration arms 14a, 14b, respectively. Similarly, on the tip portions of the detecting vibration arms 16a, 16b on an opposite side to the side joining the base section 10, there are disposed weight sections 18c, 18d having a width larger than the width of the detecting vibration arms 16a, 16b, respectively. By disposing such weight sections as described above, it is possible to drop the vibration frequency to thereby decrease the length of the vibration arms, and therefore, the miniaturization of the vibration element 1 can be achieved. Further, since the mass of the tip portion of the vibration arm increases, and a lot of charges can be generated, the detection sensitivity as the angular velocity sensor element can be improved. It should be noted that the weight sections 18a, 18b, 18c, 18d, 18e, and 18f can be provided if necessary, and can also be eliminated.

Then, the monitor sections 30a, 30b, and the drive sections 32a, 32b will be explained. It should be noted that the drive section denotes a piezoelectric element for driving the flexural vibration of the driving vibration arm having a displacement in a direction (the X-axis direction) in which the support arm extends, and the monitor section is a piezoelectric element for exciting the vibration of the driving vibration arm by the drive section.

The monitor sections 30a, 30b and the drive sections 32a, 32b each have a roughly rectangular shape taking the Y-axis direction as the longitudinal direction, and are disposed on the driving vibration arms 14a, 14b of the vibration element 1 describe above. Further, the monitor sections 30a, 30b and the drive sections 32a, 32b are arranged side by side with a distance from each other in the width direction of the driving vibration arms 14a, 14b, and the monitor sections 30a, 30b are disposed on the side, on which the base section 10 is disposed, in the width direction (the X-axis direction) of the driving vibration arms 14a, 14b.

As shown in FIG. 1A, the monitor sections 30a, 30b are disposed so as to extend in a direction (the Y-axis direction) toward the side, on which the detecting vibration arm 16a joins the base section 10, from the central portions of the driving vibration arms 14a, 14b joining the support arms 12a, 12b. Further, the monitor section 30a disposed on the driving vibration arm 14a and the monitor section 30b disposed on the driving vibration arm 14b are connected to each other with a wiring section 44 disposed on the support arms 12a, 12b and the base section 10. Further, the monitor sections 30a, 30b are also connected to a connection terminal section 36 disposed on the base section 10 with the wiring section 44 disposed on the base section 10.

The drive sections 32a, 32b are disposed so as to extend in both directions (toward the + side and the − side of the Y axis) from the central sections of the driving vibration arms 14a, 14b joining the support arms 12a, 12b, respectively. Further, the drive section 32a disposed on the driving vibration arm 14a and the drive section 32b disposed on the driving vibration arm 14b are connected to each other with a wiring section 46 disposed on the support arms 12a, 12b and the base section 10. Further, the drive sections 32a, 32b are also connected to a connection terminal section 38 disposed on the base section 10 with the wiring section 46 disposed on the base section 10.

Then, laminate configurations of the drive sections 32a, 32b and the monitor sections 30a, 30b will be explained.

As shown in FIG. 1B, the drive section 32a includes a first electrode layer 50a, a second electrode layer 52a, and a first piezoelectric layer 60a, and is disposed on the driving vibration arm 14a. The first piezoelectric layer 60a is disposed between the first electrode layer 50a and the second electrode layer 52a, and the first electrode layer 50a is disposed on the driving vibration arm 14a.

Further, the monitor section 30a similarly includes a third electrode layer 50b, a fourth electrode layer 52b, and a second piezoelectric layer 60b, and is disposed on the driving vibration arm 14a. The second piezoelectric layer 60b is disposed between the third electrode layer 50b and the fourth electrode layer 52b, and the third electrode layer 50b is disposed on the driving vibration arm 14a.

It should be noted that the first electrode layer 50a and the third electrode layer 50b respectively constituting the drive section 32a and the monitor section 30a are respectively formed of the same electrode layers using a photolithography technology, the second electrode layer 52a and the fourth electrode layer 52b respectively constituting the drive section 32a and the monitor section 30a are respectively formed of the same electrode layers using a photolithography technology, and the first piezoelectric layer 60a and the second piezoelectric layer 60b respectively constituting the drive section 32a and the monitor section 30a are respectively formed of the same piezoelectric layers using a photolithography technology. Therefore, these layers will hereinafter be explained collectively as the first electrode layer 50, the second electrode layer 52, and the piezoelectric layer 60.

Therefore, besides the drive sections 32a, 32b and the monitor section 30a, 30b, the detection sections 34a, 34b, 34c, and 34d, the wiring sections 44, 46, and the connection terminal sections 36, 38, 40a, 40b, 40c, and 40d each have the configuration in which the piezoelectric layer 60 is disposed between the first electrode layer 50 and the second electrode layer 52, and the first electrode layer 50 is disposed on the substrate 8 including the vibration arms, the base section, and so on.

Then, the detection sections 34a, 34b, 34c, and 34d will be explained. It should be noted that the detection section is a piezoelectric element for generating charges due to the flexural vibration of the detecting vibration arm including a displacement in the extending direction of the support arms.

The detection sections 34a, 34b, 34c, and 34d each have a roughly rectangular shape taking the Y-axis direction as the longitudinal direction, and are disposed on the detecting vibration arms 16a, 16b of the vibration element 1. Further, the detection sections 34a, 34b are disposed side by side with a distance from each other in the width direction (the X-axis direction) of the detecting vibration arm 16a, and the detection section 34c, 34d are disposed side by side with a distance from each other in the width direction (the X-axis direction) of the detecting vibration arm 16b.

The detection section 34a is connected to the connection terminal section 40a disposed on the base section 10, and is disposed so as to extend toward (toward the − side of the Y axis) the weight section 18c joining the tip portion of the detecting vibration arm 16a.

The detection section 34b is connected to the connection terminal section 40b disposed on the base section 10, and is disposed so as to extend toward (toward the − side of the Y axis) the weight section 18c joining the tip portion of the detecting vibration arm 16a.

The detection section 34c is connected to the connection terminal section 40c disposed on the base section 10, and is disposed so as to extend toward (toward the + side of the Y axis) the weight section 18d joining the tip portion of the detecting vibration arm 16b.

The detection section 34d is connected to the connection terminal section 40d disposed on the base section 10, and is disposed so as to extend toward (toward the + side of the Y axis) the weight section 18d joining the tip portion of the detecting vibration arm 16b.

Further, the laminate configuration of each of the detection sections 34a, 34b, 34c, and 34d is formed as a configuration including the first electrode layer 50, the second electrode layer 52, and the piezoelectric layer 60 similarly to the case of the monitor sections 30a, 30b and the drive sections 32a, 32b. It should be noted that the wiring sections 44, 46 and the connection terminal sections 36, 38, 40a, 40b, 40c, and 40d described above are formed to have substantially the same laminate configurations.

It should be noted that the second electrode layers 52 have substantially the same arrangement configuration as the piezoelectric layers 60, the monitor sections 30a, 30b and the drive sections 32a, 32b are electrically connected to the connection terminal sections 36, 38 by the wiring sections 44, 46 disposed on the support arms 12a, 12b and the base section 10, respectively, and the detection sections 34a, 34b, 34c, and 34d are electrically connected to the connection terminal sections 40a, 40b, 40c, and 40d, respectively. However, in the first electrode layers 50, the six connection terminal sections 36, 38, 40a, 40b, 40c, and 40d and the connection terminal sections 42a, 42b to be ground terminals are electrically connected to each other by a wiring section 48 disposed on the base section 10. Further, in the present embodiment, the number of the connection terminal sections 42a, 42b to be the ground terminals to which the six connection terminal sections 36, 38, 40a, 40b, 40c, and 40d are electrically connected in the first electrode layers 50 is two, but the number can be one.

Here, the vibration action of the angular velocity sensor element as the vibration element 1 according to the first embodiment of the invention will be explained.

In the drive sections 32a, 32b disposed on the driving vibration arms 14a, 14b, when a voltage is applied between the first electrode layer 50 and the second electrode layer 52, an electric field in the Z-axis direction occurs in the piezoelectric layer 60, and the piezoelectric layer 60 expands or contracts in the Y-axis direction. As shown in FIG. 1A, the drive sections 32a, 32b are disposed on the opposite side to the side where the base section 10 is disposed in the width direction (the X-axis direction) of the driving vibration arms 14a, 14b, respectively. Therefore, when the drive sections 32a, 32b contract in the Y-axis direction due to the energization, the contraction occurs on the opposite side of the driving vibration arms 14a, 14b to the side, on which the base section 10 is disposed, and thus, there occurs the flexural vibration having a displacement in the X-axis direction. Further, the flexural vibration (the driving vibration) occurs in the driving vibration arm 14a and the driving vibration arm 14b so that the driving vibration arm 14a and the driving vibration arm 14b come closer to and get away from each other.

Further, the detection sections 34a, 34b, 34c, and 34d disposed on the detecting vibration arms 16a, 16b are configured so that the piezoelectric layer 60 is expanded or contracted in the Y-axis direction due to the flexural vibration including a displacement of the detecting vibration arms 16a, 16b in the X-axis direction, and the electrical field in the Z-axis direction is caused in the piezoelectric layer 60 to thereby output charges between the first electrode layer 50 and the second electrode layer 52. Such detection sections 34a, 34b as described above each output the charges due to the vibration (the flexural vibration in the X-axis direction) of the detecting vibration arm 16a. Similarly, the detection sections 34c, 34d each output the charges due to the vibration (the flexural vibration in the X-axis direction) of the detecting vibration arm 16b.

It should be noted that the detection sections 34a, 34b are disposed side by side with a distance from each other in the width direction (the X-axis direction) of the detecting vibration arm 16a, and have the respective electrodes in a positive-negative configuration. Therefore, when the flexural vibration (a so-called in-plane vibration) having the displacement of the detecting vibration arm 16a in the X-axis direction occurs, the detection section 34b contracts in the case in which the detection section 34a expands, and the detection section 34b expands in the case in which the detection section 34a contracts. Similarly, the detection sections 34c, 34d are disposed side by side with a distance from each other in the width direction (the X-axis direction) of the detecting vibration arm 16b, and have the respective electrodes in a positive-negative configuration. Therefore, when the flexural vibration (a so-called in-plane vibration) having the displacement of the detecting vibration arm 16b in the X-axis direction occurs, the detection section 34d contracts in the case in which the detection section 34c expands, and the detection section 34d expands in the case in which the detection section 34c contracts.

In the case in which angular velocity ω fails to be applied to the vibrator element 1 as the angular velocity sensor element, since the driving vibration arm 14a and the driving vibration arm 14b vibrate plane-symmetrically about the Y-Z plane passing through the center of gravity G (not shown) of the vibration element 1, the base section 10 and the detecting vibration arms 16a, 16b hardly vibrate.

In the state in which the driving vibration occurs in the driving vibration arms 14a, 14b as described above, when the angular velocity ω around the normal line passing through the center of gravity G is applied to the vibration element 1, the Coriolis force acts on each of the driving vibration arms 14a, 14b. Thus, the support arms 12a, 12b vibrate flexurally in the Y-axis direction, and due to the flexural vibration, a flexural vibration (detecting vibration) of the detecting vibration arms 16a, 16b in the X-axis direction is excited so as to cancel out the moment caused by the flexural vibration of the support arms 12a, 12b.

Then, the charges generated in the detection sections 34a, 34b due to the flexural vibration of the detecting vibration arm 16a are output from the connection terminal sections 40a, 40b. Further, the charges generated in the detection sections 34c, 34d due to the flexural vibration of the detecting vibration arm 16b are output from the connection terminal sections 40c, 40d.

The angular velocity ω applied to the vibration element 1 can be obtained based on the charges output from the connection terminal sections 40a, 40b, 40c, and 40d in such a manner as described above.

Then, a drive circuit for driving the vibration element and a detection circuit for detecting the angular velocity ω will be explained.

FIG. 2 is a schematic diagram showing a cross-sectional view of the vibration element according to the first embodiment of the invention along the B-B line shown in FIG. 1A, and a circuit configuration.

The drive circuit section 90 for driving the driving vibration arm 14a, 14b of the vibration element 1 is configured including an operational amplifier 70a, an electronic component 72a such as a capacitor or a resistor, an automatic gain control (AGC) 74, and a drive circuit 76 for driving the drive section 32a.

By the drive circuit 76 applying a voltage between the first electrode layer 50 and the second electrode layer 52 of the drive sections 32a disposed on the driving vibration arm 14a, the electric field in the Z-axis direction occurs in the piezoelectric layer 60, and the piezoelectric layer 60 expands or contracts in the Y-axis direction, and thus, there occurs the flexural vibration of the driving vibration arm 14a having the displacement in the X-axis direction. Due to the flexural vibration, the monitor section 30a contracts in the case in which the drive section 32a expands, and expands in the casein which the drive section 32a contracts. Therefore, the electrical field in the Z-axis direction occurs in the piezoelectric layer 60 of the monitor section 30a, and the charges corresponding to the amplitude of the flexural vibration of the driving vibration arm 14a are generated between the first electrode layer 50 and the second electrode layer 52.

Subsequently, the charges thus generated are input from the second electrode layer 52 to a charge amplifier (a current-voltage conversion circuit) constituted by the operational amplifier 70a and the electronic component 72a of the drive circuit section 90, then amplified, and then output as a monitor voltage since the first electrode layer 50 is grounded. Then, the monitor voltage corresponding to the amplitude of the flexural vibration is converted by the AGC 74 into a constant voltage, then applied to the drive circuit 76, and subsequently, the constant voltage corresponding to the monitor voltage is applied by the drive circuit 76 to the first electrode layer 50 and the second electrode layer 52 of the drive section 32a, and thus, it is possible to drive the stable flexural vibration. Therefore, by disposing the monitor sections 30a, 30b on the driving vibration arms 14a, 14b, there is obtained an advantage that the constant voltage sufficient to drive the flexural vibration can be supplied to the drive sections 32a, 32b, and thus, it is possible to stably drive the flexural vibrations of the driving vibration arms 14a, 14b.

The detection circuit section 92 for detecting the charges generated in the detecting vibration arms 16a, 16b of the vibration element 1 is configured including operational amplifiers 70b, 70c, electronic components 72b, 72c such as a capacitor or a resistor, a differential amplifier 78, a synchronous detection circuit 80, and a low-pass filter (LPF) 82.

The charges generated from the detection sections 34a, 34b disposed on the detecting vibration arm 16a due to the angular velocity ω applied to the vibration element 1 are amplified by each of two charge amplifiers formed of the operational amplifiers 70b, 70c and the electronic components 72b, 72c such as the capacitor or the resistor, and the charges generated from the two detection sections 34a, 34b are added to each other in the differential amplifier 78. Subsequently, the result is converted by the synchronous detection circuit 80 into a direct-current component, and then a high-frequency noise component is removed by the LPF 82, and thus, the direct-current component proportional to the angular velocity ω applied to the vibration element 1 can be detected.

Hereinafter, the structure, the principle of action, the drive circuit, and the detection circuit of the vibration element 1 are explained. Then, the materials constituting the vibration element 1 will be explained.

As the material of the substrate 8 constituting the vibration element 1, there can be cited, for example, silicon, quartz, and glass. In particular, silicon is preferable, because the vibration element 1 having an excellent vibration characteristic can be realized at a relatively moderate price, and further, the vibration element 1 can be formed with high dimensional accuracy by etching using a known microfabrication technology (a photolithography technology).

The first electrode layer 50 can be formed of a metal material such as gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), or zirconium (Zr), or a transparent electrode material such as ITO or ZnO.

Among these materials, as the constituent material of the first electrode layer 50, the metal (gold and a gold alloy) containing gold as the principal material, or platinum is preferably used, and the metal (in particular gold) containing gold as the principal material is further preferably used.

In particular, Gold (Au) is superior (low in electrical resistance) in conductivity and resistance characteristics to oxidation, and is therefore suitable as the electrode material. Further, gold can easily be patterned by etching compared to platinum. Further, by forming the first electrode layer 50 with gold or a gold alloy, the orientation of the piezoelectric layer 60 can also be improved.

Further, the average thickness of the first electrode layer 50 is not particularly limited, but is preferably in a range of about 1 through 300 nm, and is further preferably in a range of 10 through 200 nm. Thus, it is possible to make the conductivity of such a first electrode layer 50 as described above excellent while preventing the first electrode layer 50 from exerting a harmful influence on the drive characteristics of drive sections 32a, 32b and the vibration characteristics of the driving vibration arms 14a, 14b.

As the constituent material (the piezoelectric material) of the piezoelectric layer 60, there can be cited, for example, zinc oxide (ZnO), aluminum nitride (AlN), lithium tantalate (LiTaO₃), lithium niobate (LiNbO₃), potassium niobate (KNbO₃), lithium tetraborate (Li₂B₄O₇), barium titanate (BaTiO₃), lead zirconium titanate (PZT).

Among these materials, PZT is preferably used as the constituent material of the piezoelectric layer 60. PZT (lead zirconium titanate) is superior in c-axis orientation, and reduction in impedance can be achieved. Therefore, by forming the piezoelectric layer 60 using PZT as the principal material, the CI-value of the vibration element 1 can be reduced. Further, these materials can be deposited by a reactive sputtering method.

Further, the average thickness of the piezoelectric layer 60 is preferably in a range of 50 through 3000 nm, and further preferably in a range of 200 through 2000 nm. Thus, the drive characteristics of the drive sections 32a, 32b and the detection characteristics of the detection sections 34a, 34b, 34c, and 34d can be made superior while preventing the piezoelectric layer 60 from exerting a harmful influence on the vibration characteristics of the driving vibration arms 14a, 14b and the detecting vibration arms 16a, 16b.

The second electrode layer 52 can be formed of a metal material such as gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), or zirconium (Zr), or a transparent electrode material such as ITO or ZnO.

Further, the average thickness of the second electrode layer 52 is not particularly limited, but is preferably in a range of about 1 through 300 nm, and is further preferably in a range of 10 through 200 nm. Thus, it is possible to make the conductivity of the second electrode layer 52 excellent while preventing the second electrode layer 52 from exerting a harmful influence on the drive characteristics of drive sections 32a, 32b and the vibration characteristics of the driving vibration arms 14a, 14b.

It should be noted that it is possible to dispose a foundation layer between the driving vibration arms 14a, 14b and the first electrode layer 50 or between the piezoelectric layer 60 and the second electrode layer 52. By disposing the foundation layer, it is possible to prevent the first electrode layer 50 from breaking away from the driving vibration arms 14a, 14b, or the second electrode layer 52 from breaking away from the piezoelectric layer 60.

The foundation layer is formed of, for example, Ti or Cr, and the average thickness of the foundation layer is not particularly limited, but is preferably in a range of about 1 through 300 nm.

Further, it is also possible to dispose an insulator layer (an insulating protective layer) between the piezoelectric layer 60 and the second electrode layer 52, or between the piezoelectric layer 60 and the foundation layer described above. This is because, the insulator layer has a function of protecting the piezoelectric layer 60, and at the same time preventing the short circuit between the first electrode layer 50 and the second electrode layer 52. The insulator layer is formed of, for example, silicon oxide (SiO₂), aluminum nitride (AlN), or silicon nitride (SiN), and the average thickness of the insulator layer is not particularly limited, but is preferably in a range of 50 through 500 nm. This is because, if the thickness of the insulator layer is smaller than the lower limit value described above, the effect of preventing the short circuit described above tends to be reduced, and in contrast, if the thickness of the insulator layer exceeds the upper limit value described above, a harmful influence might be exerted on the characteristics of the monitor sections, drive sections 32a, 32b, and the detection sections 34a, 34b, 34c, and 34d.

Then, modified example 1 through modified example 3 in the configuration of the piezoelectric element and the electrodes of the vibration element according to the first embodiment of the invention will be explained.

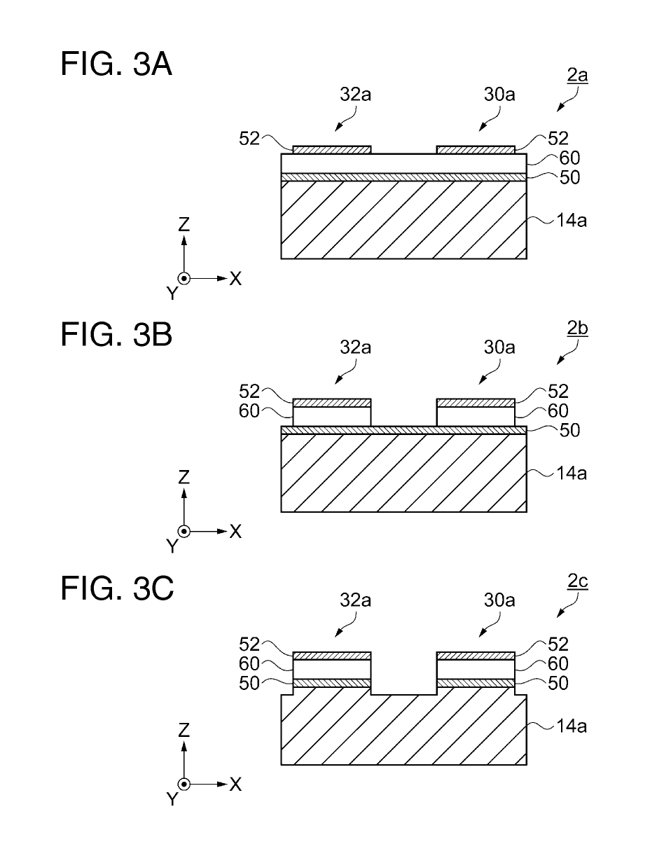

FIGS. 3A through 3C are each a cross-sectional view showing a modified example in the configuration of the piezoelectric element and the electrodes of the vibration element according to the first embodiment of the invention along the A-A line shown in FIG. 1A, wherein FIG. 3A is a cross-sectional view showing modified example 1, FIG. 3B is a cross-sectional view showing modified example 2, and FIG. 3C is a cross-sectional view showing modified example 3.

Hereinafter, in the description of modified examples 1, 2, and 3, the explanation will be presented mainly focused on the differences from the embodiment shown in FIGS. 1A and 1B described above, and the explanation of substantially the same matters will be omitted. It should be noted that the constituents substantially the same as those of the first embodiment described above are denoted with the same reference symbols.

### Modified Example 1

As shown in FIG. 3A, the vibration element 2a according to modified example 1 is different from the vibration element 1 according to the first embodiment in the point that the pattern of the monitor section 30a and the drive section 32a is not formed in the first electrode layer 50 and the piezoelectric layer 60. Since the electrical field in the Z-axis direction occurs in the piezoelectric layer 60 only in the part where the first electrode layer 50, the piezoelectric layer 60, and the second electrode layer 52 overlap each other when applying a voltage between the first electrode layer 50 and the second electrode layer 52, there is no problem on driving the driving vibration arm 14a even if the pattern of the monitor section 30a and the drive section 32a is not formed in the first electrode layer 50 and the piezoelectric layer 60. Further, by eliminating the patterning process of the first electrode layer 50 and the piezoelectric layer 60 by etching, there is obtained an advantage that it is possible to reduce the processing time to thereby achieve reduction in manufacturing cost.

### Modified Example 2

As shown in FIG. 3B, the vibration element 2b according to modified example 2 is different from the vibration element 1 according to the first embodiment in the point that the pattern of the monitor section 30a and the drive section 32a is not formed in the first electrode layer 50. Since the electrical field in the Z-axis direction occurs in the piezoelectric layer 60 only in the part where the first electrode layer 50, the piezoelectric layer 60, and the second electrode layer 52 overlap each other when applying a voltage between the first electrode layer 50 and the second electrode layer 52, there is no problem on driving the driving vibration arm 14a even if the pattern of the monitor section 30a and the drive section 32a is not formed in the first electrode layer 50. Further, by eliminating the patterning process of the first electrode layer 50 by etching, there is obtained an advantage that it is possible to reduce the processing time to thereby achieve reduction in manufacturing cost.

### Modified Example 3

As shown in FIG. 3C, the vibration element 2c according to modified example 3 is different from the vibration element 1 according to the first embodiment in the point that the pattern of the monitor section 30a and the drive section 32a is also formed in a part of the driving vibration arm 14a as the substrate. By forming the pattern of the monitor section 30a and the drive section 32a in the driving vibration arm 14a, the vibration energy excited by the monitor section 30a and the drive section 32a is confined to the part where the monitor section 30a and the drive section 32a are patterned to thereby reduce the leakage of the vibration energy. Therefore, there is obtained an advantage that the vibration element 2c low in impedance can be obtained.

### Second Embodiment

Then, a second embodiment of the invention will be explained.

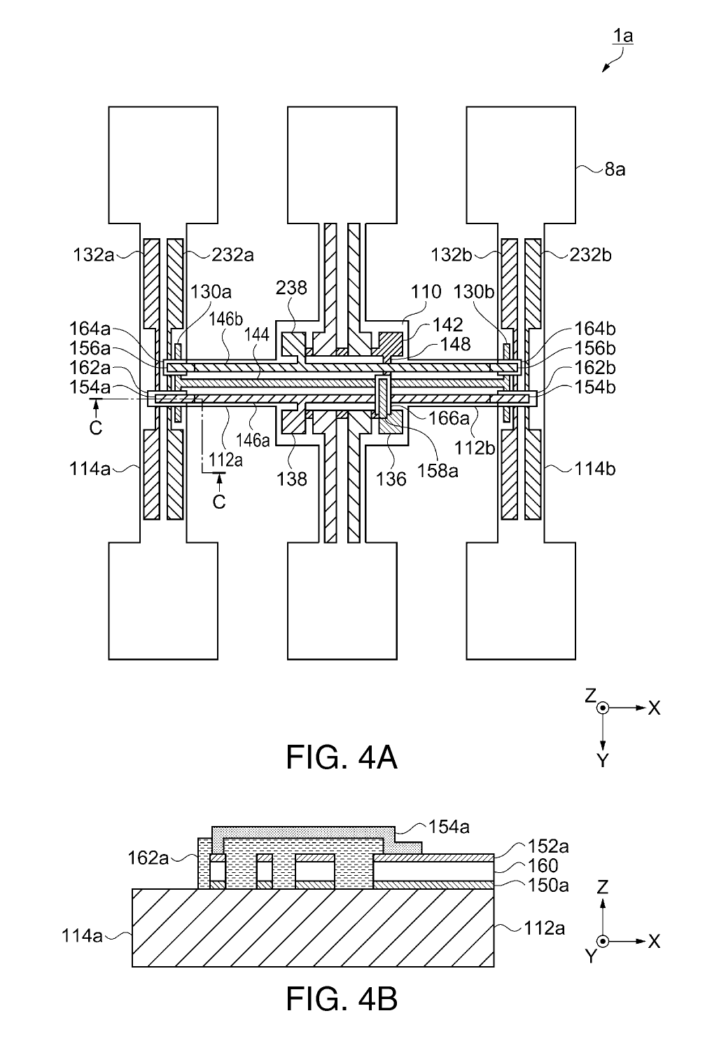

FIGS. 4A and 4B are schematic diagrams showing a structure of a vibration element according to the second embodiment of the invention, wherein FIG. 4A is a plan view, and FIG. 4B is a cross-sectional view along the C-C line in FIG. 4A.

Hereinafter, the vibration element 1a according to the second embodiment will be explained focusing mainly on the differences from the vibration element 1 according to the first embodiment described above, and the explanation regarding substantially the same matters will be omitted.

As shown in FIGS. 4A and 4B, the vibration element 1a according to the second embodiment is different from the vibration element 1 in the configuration of drive sections 132a, 132b, 232a, and 232b and monitor sections 130a, 130b although the outer shape of a substrate 8a is comparable with the outer shape of the substrate 8 of the vibration element 1 according to the first embodiment.

The drive sections 132a, 132b, 232a, and 232b are disposed so as to extend in both directions (toward the + side and the − side of the Y axis) from the central sections of driving vibration arms 114a, 114b joining support arms 112a, 112b, respectively. Further, the drive sections 132a, 232a on the driving vibration arm 114a are disposed side by side with a distance from each other in the width direction (the X-axis direction) of the driving vibration arm 114a, and the drive section 132b, 232b on the driving vibration arm 114b are disposed side by side with a distance from each other in the width direction (the X-axis direction) of the driving vibration arm 114b. Further, the two drive sections 232a, 132b are disposed respectively on the driving vibration arms 114a, 114b on the side on which the base section 110 is disposed.

It should be noted that by disposing the drive sections 132a, 132b, 232a, and 232b so that the pair of drive sections 132a, 232a are disposed side by side on the driving vibration arm 114a, and the pair of drive sections 132b, 232b are disposed side by side on the driving vibration arm 114b, it is possible to increase the drive force for the flexural vibration of the driving vibration arms 114a, 114b to thereby dramatically decrease the impedance. Therefore, there is obtained an advantage that it is possible to easily drive the flexural vibrations of the driving vibration arms 114a, 114b.

As shown in FIG. 4A, the two drive sections 132a, 232b disposed respectively on the driving vibration arms 114a, 114b are connected to each other by a wiring section 146a disposed on support arms 112a, 112b and a base section 110, and connection electrodes 154a, 154b formed on insulating materials 162a, 162b disposed for preventing the short circuit with the monitor sections 130a, 130b and the drive sections 232a, 132b disposed on the driving vibration arms 114a, 114b.

Further, similarly, the two drive sections 232a, 132b disposed respectively on the driving vibration arms 114a, 114b are connected to each other by a wiring section 146b disposed on the support arms 112a, 112b and the base section 110, and connection electrodes 156a, 156b formed on insulating materials 164a, 164b disposed for preventing the short circuit with the monitor sections 130a, 130b disposed on the driving vibration arms 114a, 114b.

Further, the drive sections 132a, 232b are connected to a connection terminal section 138 disposed on the base section 110 by the wiring section 146a, and the drive sections 232a, 132b are connected to a connection terminal section 238 disposed on the base section 110 by the wiring section 146b. Therefore, by applying a voltage from the drive circuit 76 shown in FIG. 2 to the drive sections 132a, 132b, 232a, and 232b through the connection terminal sections 138, 238, it is possible to flexurally vibrate the driving vibration arms 114a, 114b.

The monitor sections 130a, 130b are disposed on the side on which the base section 110 is disposed in the width direction (the X-axis direction) of the driving vibration arms 114a, 114b so as to extend in both directions (toward the + side and the − side of the Y axis) from the central portions on the driving vibration arms 114a, 114b joining the support arms 112a, 112b, respectively.

The monitor sections 130a, 130b disposed respectively on the driving vibration arms 114a, 114b are connected to each other by the wiring section 144 disposed on the support arms 112a, 112b, and the base section 110, and further connected to the connection terminal section 136 by the connection electrode 158a formed on an insulating material 166a disposed for preventing the short circuit with the wiring section 146b disposed on the base section 110.

Further, a connection terminal section 142 disposed on the base section 110 is formed of a first electrode layer 150a, and is electrically connected to the two connection terminal sections 136, 138 for drive, and four connection terminal sections for detection by a wiring section 148 formed of the first electrode layer 150a.

It should be noted that as shown in FIG. 4B, the structure of the insulating material 162a formed to prevent the short circuit and the connection electrode 154a for achieving the electrical connection is formed so as to be stacked on the first electrode layer 150a disposed on the driving vibration arm 114a and the support arm 112a, a piezoelectric layer 160, and a second electrode layer 150b.

The insulating materials 162a, 164a, and 166a are each formed of, for example, silicon oxide (SiO₂), aluminum nitride (AlN), or silicon nitride (SiN), and the average thickness of each of the insulating materials 162a, 164a, and 166a is not particularly limited, but is preferably in a range of 50 through 500 nm.

Further, the connection electrodes 154a, 156a, and 158a formed on the insulating materials 162a, 164a, and 166a can be formed of a metal material such as gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), or zirconium (Zr), or a transparent electrode material such as ITO or ZnO, and are not particularly limited. However, the same material as the material of the second electrode layer 152a, for example, is preferable. Further, the average thickness of each of the connection electrodes 154a, 156a, and 158a is preferably in a range of about 1 through 300 nm.

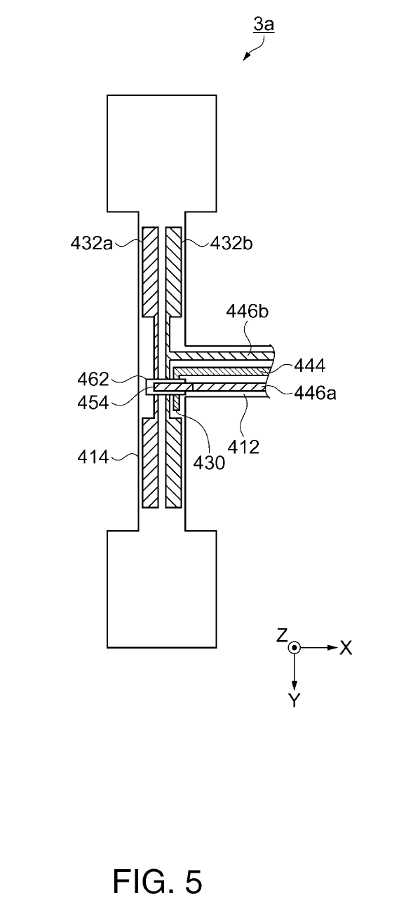

Then, modified example 1 through modified example 4 of the vibration element according to the second embodiment of the invention will be explained. It should be noted that although FIGS. 5 through 8 show only a part corresponding to the driving vibration arm 114a shown in FIG. 4A, a part corresponding to the driving vibration arm 114b has a configuration line symmetrical about a center line (not shown) of the base section 110 in the X-axis direction.

### Modified Example 1

FIG. 5 is a plan view showing a structure of modified example 1 of the vibration element according to the second embodiment of the invention.

Hereinafter, the vibration element 3a according to modified example 1 will be explained focusing mainly on the differences from the vibration element 1a according to the second embodiment described above, and the explanation regarding substantially the same matters will be omitted.

The vibration element 3a according to modified example 1 is the same as the vibration element 1a according to the second embodiment in the point that a drive section 432a formed on a driving vibration arm 414 is connected to a wiring section 446a formed on a support arm 412 by a connection electrode 454 formed on an insulating material 462 for preventing the short circuit with a monitor section 430, but is different from the vibration element 1a in the point that the monitor section 430 connected to a wiring section 444 extends toward the + side in the Y-axis direction from a central portion on the driving vibration arm 414 joining the support arm 412. Therefore, a drive section 432b disposed on the support arm 412 side of the driving vibration arm 414 can be connected to a wiring section 446b without requiring formation of an insulating material or formation of a connection electrode.

According to such a configuration as described above, it is possible to prevent formation of an insulating material and the short circuit due to formation failure of the connection electrode in the connection between the drive section 432b and the wiring section 446b, and there is obtained an advantage that a defect in the vibration element 3a can be reduced.

### Modified Example 2

Then, modified example 2 of the vibration element according to the second embodiment of the invention will be explained.

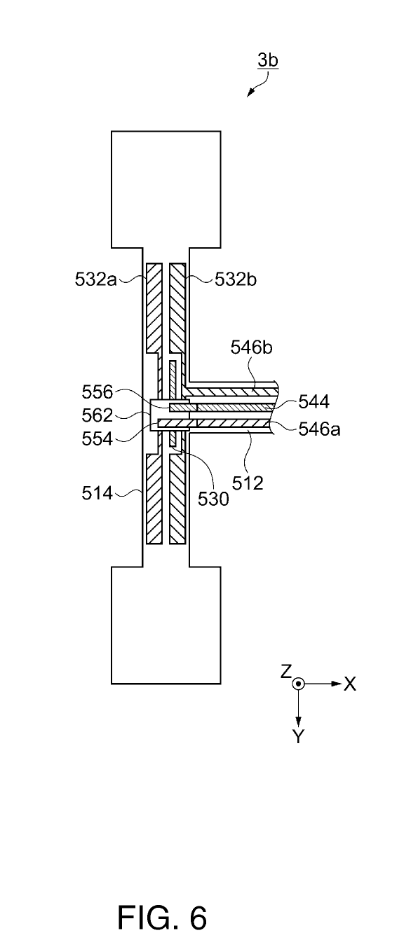

FIG. 6 is a plan view showing a structure of modified example 2 of the vibration element according to the second embodiment of the invention.

Hereinafter, the vibration element 3b according to modified example 2 will be explained focusing mainly on the differences from the vibration element 1a according to the second embodiment described above, and the explanation regarding substantially the same matters will be omitted.

The vibration element 3b according to modified example 2 is the same as the vibration element 1a according to the second embodiment in the point that a drive section 532a formed on a driving vibration arm 514 is connected to a wiring section 546a formed on a support arm 512 by a connection electrode 554 formed on an insulating material 562 for preventing the short circuit with a monitor section 530 and a drive section 532b. However, the vibration element 3b is different from the vibration element 1a in the point that the monitor section 530 is disposed on the center line (not shown) side in the width direction (the X-axis direction) on the driving vibration arm 514, the point that the drive section 532b is directly connected to a wiring section 546b, and the point that the monitor section 530 is connected to a wiring section 544 by a connection electrode 556 formed on the insulating material 562 for preventing the short circuit with the drive section 532b.

According to such a configuration as described above, since the size in the width direction (the Y-axis direction) of the insulating material 562 for preventing the short circuit with the drive section 532b can be increased, there is obtained an advantage that the short circuit between the drive section 532a and the monitor section 530 and the short circuit between the drive section 532b and the monitor section 530 can be prevented, and thus, the defect in the vibration element 3b can be reduced.

### Modified Example 3

Then, modified example 3 of the vibration element according to the second embodiment of the invention will be explained.

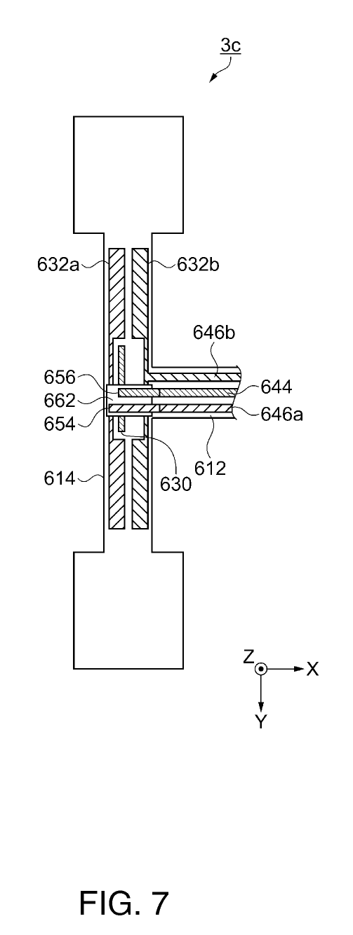

FIG. 7 is a plan view showing a structure of modified example 3 of the vibration element according to the second embodiment of the invention.

Hereinafter, the vibration element 3c according to modified example 3 will be explained focusing mainly on the differences from the vibration element 1a according to the second embodiment described above, and the explanation regarding substantially the same matters will be omitted.

The vibration element 3c according to modified example 3 is the same as the vibration element 1a according to the second embodiment in the point that a drive section 632a formed on a driving vibration arm 614 is connected to a wiring section 646a formed on a support arm 612 by a connection electrode 654 formed on an insulating material 662 for preventing the short circuit with a monitor section 630 and a drive section 632b. However, the vibration element 3c is different from the vibration element 1a in the point that the monitor section 630 is disposed on an opposite side to the support arm 612 with respect to the center line (not shown) in the width direction (the X-axis direction) on the driving vibration arm 614, the point that the drive section 632b is directly connected to a wiring section 646b, and the point that the monitor section 630 is connected to a wiring section 644 by a connection electrode 656 formed on the insulating material 662 for preventing the short circuit with the drive section 632b.

According to such a configuration as described above, since the size in the width direction (the Y-axis direction) of the insulating material 662 for preventing the short circuit with the drive section 632b can be increased, there is obtained an advantage that the short circuit between the drive section 632a and the monitor section 630 and the short circuit between the drive section 632b and the monitor section 630 can be prevented, and thus, the defect in the vibration element 3c can be reduced.

### Modified Example 4

Then, modified example 4 of the vibration element according to the second embodiment of the invention will be explained.

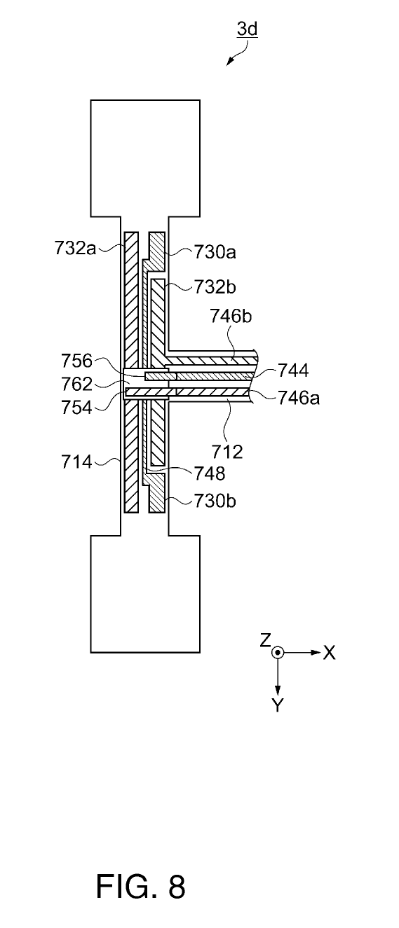

FIG. 8 is a plan view showing a structure of modified example 4 of the vibration element according to the second embodiment of the invention.

Hereinafter, the vibration element 3d according to modified example 4 will be explained focusing mainly on the differences from the vibration element 1a according to the second embodiment described above, and the explanation regarding substantially the same matters will be omitted.

The vibration element 3d according to modified example 4 is the same as the vibration element 1a according to the second embodiment in the point that a drive section 732a formed on a driving vibration arm 714 is connected to a wiring section 746a formed on a support arm 712 by a connection electrode 754 formed on an insulating material 762 for preventing the short circuit with monitor sections 730a, 730b and a drive section 732b. However, the vibration element 3d and the vibration element 1a are different in the point that the two monitor sections 730a, 730b are disposed so as to extend in both directions (toward the + side and the − side of the Y axis) from the central portion on the driving vibration arm 714, and the two monitor sections 730a, 730b are connected to each other by a wiring section 748 disposed on the driving vibration arm 714, the point that the drive section 732b is directly connected to a wiring section 746b, the point that the wiring section 748 connecting the two monitor sections 730a, 730b to each other is connected to a wiring section 744 by a connection electrode 756 formed on an insulating material 762 for preventing the short circuit with the drive section 732b, and the point that the drive sections 732a, 732b are each formed to have an even width in the X-axis direction.

According to such a configuration as described above, since the drive sections 723a, 723b are formed to have the even width in the X-axis direction, the drive force increases, and the impedance can be decreased. Therefore, there is obtained an advantage that it is possible to easily drive the flexural vibration of the driving vibration arm 714. Further, since the size in the width direction (the Y-axis direction) of the insulating material 762 for preventing the short circuit with the drive section 732b can be increased, there is obtained an advantage that the short circuit between the drive section 732a and the monitor sections 730a, 730b, and the short circuit between the drive section 732b and the monitor sections 730a, 730b can be prevented, and thus, the defect in the vibration element 3d can be reduced.

### Electronic Device

Then, an electronic device (an angular velocity sensor) to which the vibration element according to the invention is applied will be explained.

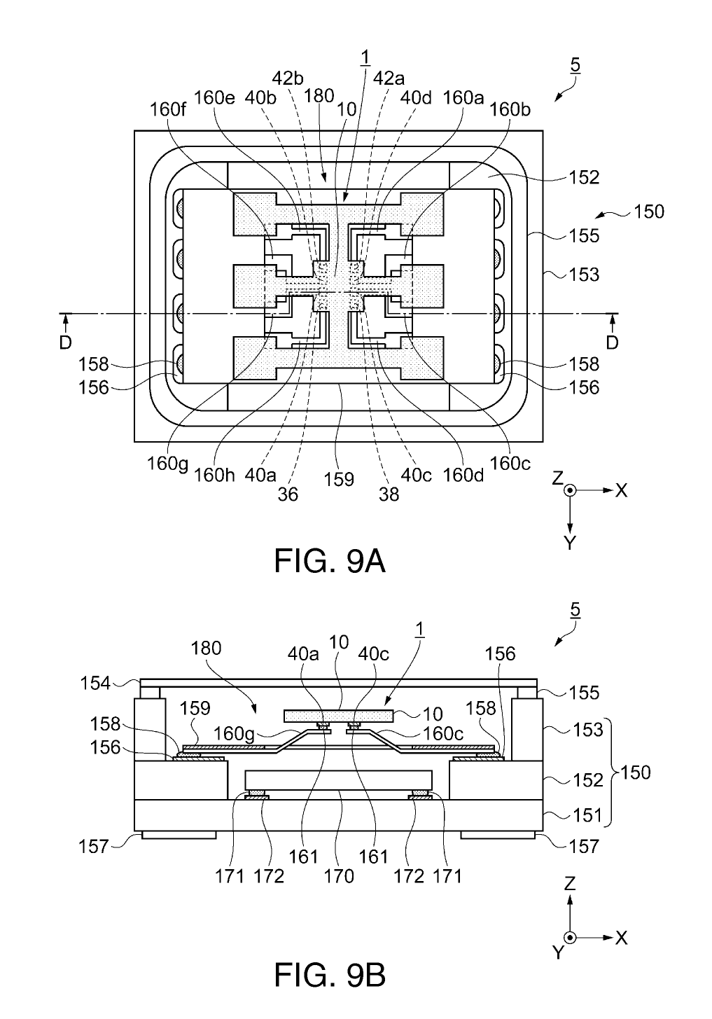

FIGS. 9A and 9B are schematic diagrams showing a structure of the electronic device equipped with the vibration element according to the invention, wherein FIG. 9A is a plan view, and FIG. 9B is a cross-sectional view along the D-D line in FIG. 9A. It should be noted that in FIG. 9A, for the sake of convenience of explanation of an internal configuration of the electronic device, there is shown the state of removing a lid member. Further, although the explanation is presented using the vibration element 1 according to the first embodiment, the vibration element 1a according to the second embodiment and the vibration elements 2a, 2b, 2c, 3a, 3b, 3c, and 3d shown as the modified examples can also be adopted.

As shown in FIG. 9A, the electronic device 5 is configured including the vibration element 1, an IC chip 170, a package main body 150 formed to have a rectangular box shape in order to house the vibration element 1 and the IC chip 170, and a lid member 154. It should be noted that the inside of a cavity 180 of the package main body 150 for housing the vibration element 1 and the IC chip 170 is provided with an inert gas atmosphere with nitrogen or the like, or a reduced-pressure atmosphere.

As shown in FIG. 9B, the package main body 150 is formed by stacking a first substrate 151, a second substrate 152, and a third substrate 153 on each other. A plurality of mounting terminals 157 is formed on an exterior bottom surface of the first substrate 151. Further, in order to mount the IC chip 170, there is disposed a plurality of connecting electrodes 172, which has electrical conduction with the mounting terminals 157 via through electrodes and inter-layer wiring (not shown), at predetermined positions on the upper surface of the first substrate 151.

The second substrate 152 is a ring-like member with the central portion removed, and is provided with the cavity 180 for housing the IC chip 170. Further, in order to mount the vibration element 1, there is disposed a plurality of connecting electrodes 156, which has electrical conduction with the connecting electrodes 172 and the mounting terminals 157 via through electrodes and inter-layer wiring (not shown), at predetermined positions on the upper surface of the second substrate 152.

The third substrate 153 is a ring-like member with the central portion removed, and is provided with the cavity 180 for housing the vibration element 1. Further, on an upper surface of the third substrate 153, there is disposed a seam ring 155 for airtightly sealing the inside of the cavity 180 when bonding the lid member 154.

The vibration element 1 is disposed so that a side of the vibration element in which the drive section or the detection section is formed is directed to the package main body 150 side and the connection terminal sections 36, 38, 40a through 40d, 42a, and 42b provided to the base section 10 respectively coincide with one ends of lead frames 160a through 160h, wherein the one ends are disposed in the center of the package main body 150, and the lead frames 160a through 160h are bonded to a support substrate 159 with a nonconductive bonding material (not shown). Further, the vibration element 1 is bonded via bonding materials 161 such as bumps made of metal, solder, or the like. Further, the other ends of the lead frames 160a through 160h are bonded to the connecting electrodes 156 provided to the second substrate 152 via an electrically-conductive bonding material 158 such as an electrically-conductive adhesive, and thus, the mechanical bonding is achieved, and at the same time, the electrical connection is also provided.

Meanwhile, the IC chip 170 is bonded to the connecting electrodes 172 disposed on the first substrate 151 via bonding materials 171 such as bumps made of metal, solder, or the like, brazing filler metal, or an electrically-conductive adhesive, and thus, the mechanical bonding is achieved, and at the same time, the electrical connection is also provided. Further, it is also possible to fill the cavity 180 surrounding the IC chip 170 with a resin material or the like to thereby fix the IC chip 170.

It should be noted that the IC chip 170 is provided with the drive circuit section 90 (see FIG. 2) for controlling the drive of the vibration element 1 and the detection circuit section 92 (see FIG. 2) for controlling the detection, and the IC chip 170 can output the direct-current component proportional to the angular velocity ω applied to the vibration element 1 to thereby detect the angular velocity ω.

The first substrate 151, the second substrate 152, and the third substrate 153 of the package main body 150 explained hereinabove are each formed of a material having an insulating property. Such a material is not particularly limited, and a variety of types of ceramics such as oxide ceramics, nitride ceramics, or carbide ceramics can be used. Further, each of the electrodes, terminals provided to the package main body 150, and wiring patterns and the inter-layer wiring patterns for electrically connecting these electrodes and terminals are typically formed by printing a metal wiring material such as tungsten (W) or molybdenum (Mo) on the insulating material by screen printing, calcining the material, and then performing plating of nickel (Ni), gold (Au), or the like on the material.

The lid member 154 can be formed using glass, ceramic, metal, and so on. It should be noted that in the case of using a light transmissive material such as borosilicate glass as the material of the lid member 154, the frequency adjustment of the driving vibration arms 14a, 14b and the detecting vibration arms 16a, 16b using a mass reduction method can be performed by externally applying a laser beam to partially evaporate the electrodes (not shown) provided to the weight sections 18a through 18f of the vibration element 1 after sealing the package main body 150. Therefore, since the frequencies of the driving vibration arms 14a, 14b and the detection vibration arms 16a, 16b can be set to desired frequencies, there is obtained an advantage that the detection accuracy as the angular velocity sensor element can further be improved.

### Electronic Apparatus

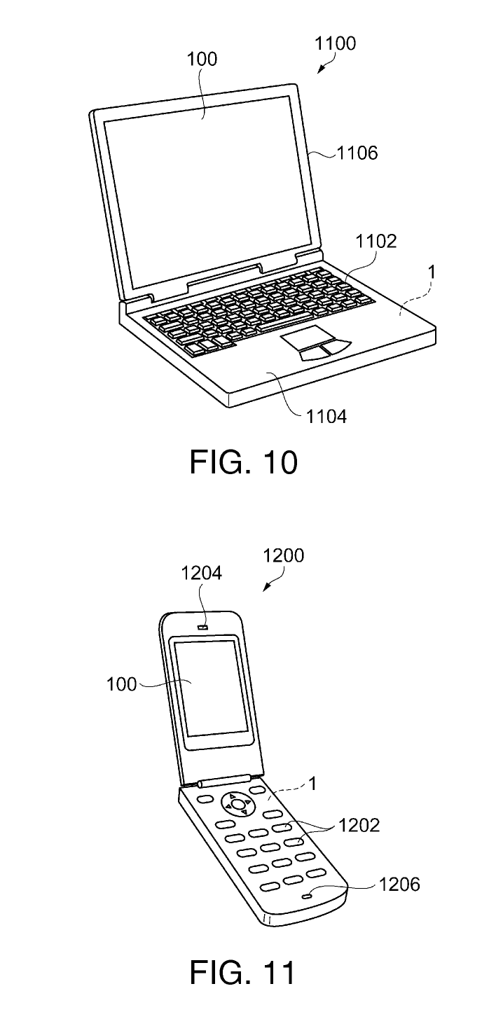

Then, some examples of the electronic apparatus to which the vibration element according to the invention is applied will be explained in detail with reference to FIGS. 10 through 12.

FIG. 10 is a perspective view showing a configuration of a mobile type (or a laptop type) personal computer as the electronic apparatus equipped with the vibration element according to the invention. In the drawing, the personal computer 1100 includes a main body section 1104 provided with a keyboard 1102, and a display unit 1106 provided with a display section 100, and the display unit 1106 is pivotally supported with respect to the main body section 1104 via a hinge structure. Such a personal computer 1100 incorporates the vibration element 1 functioning as an angular velocity sensor.

FIG. 11 is a perspective view showing a configuration of a cellular phone (including PHS) as the electronic apparatus equipped with the vibration element according to the invention. In this drawing, the cellular phone 1200 is provided with a plurality of operation buttons 1202, an ear piece 1204, and a mouthpiece 1206, and the a display section 100 is disposed between the operation buttons 1202 and the ear piece 1204. Such a cellular phone 1200 incorporates the vibration element 1 functioning as an angular velocity sensor.

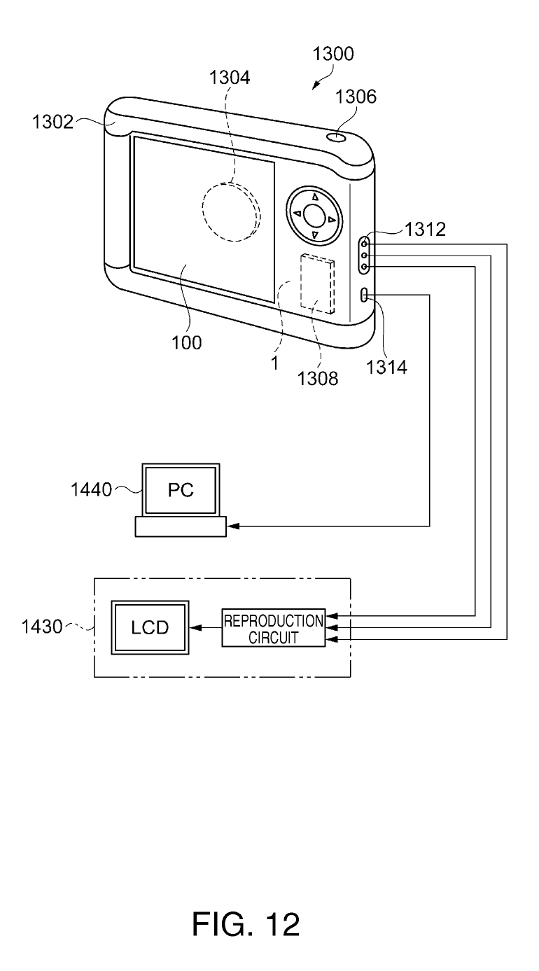

FIG. 12 is a perspective view showing a configuration of a digital camera as the electronic apparatus equipped with the vibration element according to the invention. It should be noted that the connection with external equipment is also shown briefly in this drawing. Here, typical cameras expose silver salt films to an optical image of an object on the one hand, the digital camera 1300 performs photoelectric conversion on the optical image of the object by an image capture element such as a CCD (a charge coupled device) to generate an imaging signal (an image signal), on the other hand.

A case (a body) 1302 of the digital camera 1300 is provided with the display section 100 disposed on the back surface thereof to have a configuration of performing display in accordance with the imaging signal from the CCD, wherein the display section 100 functions as a viewfinder for displaying the object as an electronic image. Further, the front surface (the back side in the drawing) of the case 1302 is provided with a light receiving unit 1304 including an optical lens (an imaging optical system), the CCD, and so on.

When the photographer checks an object image displayed on the display section 100, and then holds down a shutter button 1306, the imaging signal from the CCD at that moment is transferred to and stored in a memory device 1308. Further, the digital camera 1300 is provided with video signal output terminals 1312 and an input/output terminal 1314 for data communication disposed on a side surface of the case 1302. Further, as shown in the drawing, a television monitor 1430 and a personal computer (PC) 1440 are respectively connected to the video signal output terminals 1312 and the input/output terminal 1314 for data communication if needed. Further, there is adopted the configuration in which the imaging signal stored in the memory device 1308 is output to the television monitor 1430 and the personal computer 1440 in accordance with a predetermined operation. Such a digital camera 1300 incorporates the vibration element 1 functioning as an angular velocity sensor.

It should be noted that, as the electronic apparatus equipped with the vibration element according to the invention, there can be cited, for example, an inkjet ejection device (e.g., an inkjet printer), a laptop personal computer, a television set, a video camera, a video cassette recorder, a car navigation system, a pager, a personal digital assistance (including one with communication function), an electronic dictionary, an electric calculator, a computerized game machine, a word processor, a workstation, a video phone, a security video monitor, a pair of electronic binoculars, a POS terminal, a medical device (e.g., an electronic thermometer, an electronic manometer, an electronic blood sugar meter, an electrocardiogram measurement instrument, an ultrasonograph, and an electronic endoscope), a fish detector, various types of measurement instruments, various types of gauges (e.g., gauges for a vehicle, an aircraft, or a ship), and a flight simulator, besides the personal computer (the mobile personal computer) shown in FIG. 10, the cellular phone shown in FIG. 11, and the digital camera shown in FIG. 12.

### Moving Object

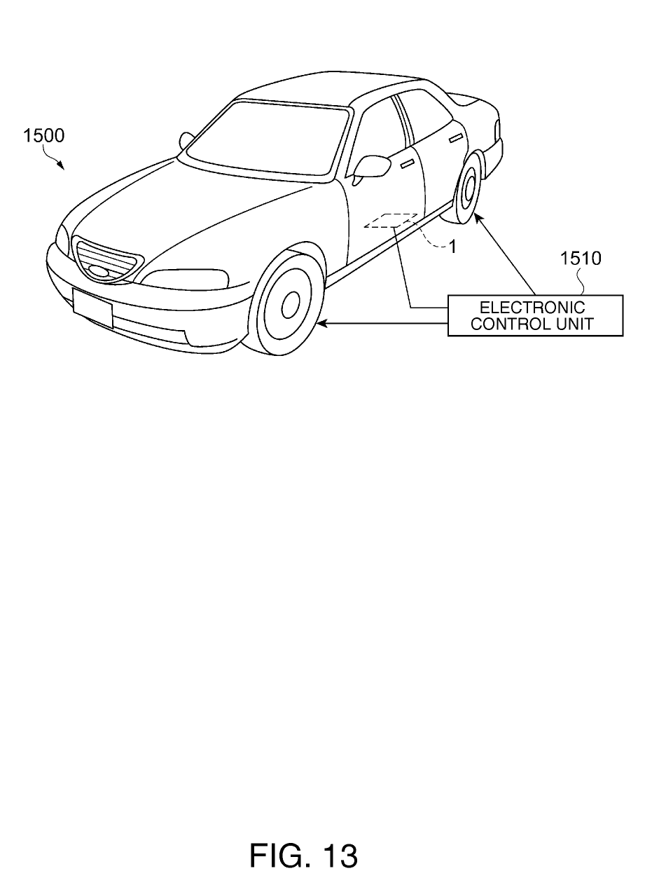

FIG. 13 is a perspective view schematically showing a vehicle 1500 as the moving object equipped with the vibration element according to the invention. In the drawing, an electronic control unit 1510 for controlling tires incorporates the vibration element 1 functioning as the angular velocity sensor.

The vibration element according to the invention is installed in the vehicle 1500, and can widely be applied to an electronic control unit (ECU) 1510 such as a keyless entry system, an immobilizer, a car navigation system, a car air-conditioner, an antilock brake system (ABS), an air-bag system, a tire pressure monitoring system (TPMS), an engine controller, a battery monitor for a hybrid car or an electric car, or a vehicle posture control system.

Although the vibration element, the vibratory device, the electronic apparatus, and the moving object according to the embodiments of the invention are hereinabove explained based on the accompanying drawings, the invention is not limited to the embodiments, but the configuration of each of the constituents can be replaced with one having an arbitrary configuration with an equivalent function. Further, it is also possible to add any other constituents to the invention. Further, it is also possible to arbitrarily combine any of the embodiments.

The entire disclosure of Japanese Patent Application No. 2013-079256, filed Apr. 5, 2013 is expressly incorporated by reference herein.

What is claimed is:

1. A vibration element comprising:
a base section;
a support arm extending from the base section;
a driving vibration arm extending from the support arm in a direction intersecting with the extending direction of the support arm;
a drive section provided to the driving vibration arm, and the drive section comprising a first laminate configuration having a first electrode layer, a second electrode layer, and a first piezoelectric layer disposed between the first electrode layer and the second electrode layer; and
a monitor section generating a charge corresponding to a vibration of the driving vibration arm, provided to the driving vibration arm, and the monitor section comprising a second laminate configuration having a third electrode layer, a fourth electrode layer, and a second piezoelectric layer disposed between the third electrode layer and the fourth electrode layer.

2. The vibration element according to claim 1, wherein
the drive section and the monitor section are disposed side by side having a distance from each other in a width direction of the driving vibration arm.

3. The vibration element according to claim 1, wherein
the drive section includes a first drive section and a second drive section disposed side by side having a distance from each other in a width direction of the driving vibration arm.

4. The vibration element according to claim 1, wherein
the monitor section is disposed nearer to the base section than the drive section in a plan view of the driving vibration arm.

5. The vibration element according to claim 4, wherein
the monitor section is disposed above one side of the driving vibration arm in a direction intersecting with the support arm.

6. The vibration element according to claim 3, wherein
the monitor section is disposed between the first drive section and the second drive section, and a center line with respect to a width direction of the monitor section and a center line with respect to a width direction of the driving vibration arm fail to conform with each other in a plan view of the driving vibration arm.

7. The vibration element according to claim 1, further comprising:
a detecting vibration arm extending from the base section in the direction intersecting with the extending direction of the support arm.

8. The vibration element according to claim 1, wherein
the base section is provided with terminals electrically connected respectively to the drive section and the monitor section.

9. A vibration element comprising:
a driving vibration arm extending along an X-Y plane defined by an X axis and a Y axis, and vibrating in at least an X-axis direction assuming three imaginary axis perpendicular to each other as the X axis, the Y axis, and a Z axis; and
a detecting vibration arm extending along the X-Y plane defined by the X axis and the Y axis, and being displaced along the X-Y plane when an angular velocity around the Z axis is applied,
wherein the driving vibration arm is provided with a monitor section generating a charge corresponding to a vibration of the driving vibration arm.

10. An electronic device comprising:
the vibration element according to claim 1; and
a circuit element.

11. An electronic device comprising:
the vibration element according to claim 9; and
a circuit element.

12. An electronic apparatus comprising:
the vibration element according to claim 1.

13. An electronic apparatus comprising:
the vibration element according to claim 9.

14. A moving object comprising:
the vibration element according to claim 1.

15. A moving object comprising:
the vibration element according to claim 9.
